(19) United States
(12) Patent Application Publication
(10) Pub. No.: US 2007/0297556 A1
(43) Pub. Date: Dec. 27, 2007

(54) FULL FUNCTION PRECISION WELDING SYSTEM

(76) Inventors: Keith Spencer, Clover, SC (US); Bradley Powell, Matthews, NC (US)

Correspondence Address: ADAMS EVANS P.A., Suite 2350 Charlotte Plaza, 201 South College Street, CHARLOTTE, NC, 28244, US

(21) Appl. No.: 11/752,733

(22) Filed: May 23, 2007

Related U.S. Application Data
(60) Provisional application No. 60/803,103, filed on May 24, 2006.

(51) Int. Cl. G21C 17/00

(52) U.S. Cl. 376/245

(57) ABSTRACT

A welding system for performing a welding process on a pipe in a confined space includes a motor housing, a weld head assembly and an insertion tube that extends between the motor housing and the weld head assembly with the weld head assembly remote from the motor housing. The motor housing is supported on a platform for rotational and translational movement of the weld head assembly and houses a motor for positioning the weld head assembly relative to the pipe. The weld head assembly includes a clamp assembly for attaching the weld head assembly to the pipe and a weld tool assembly mounted adjacent the clamp assembly for welding the pipe. An arc length gear and a travel gear adjust the distance between a torch assembly and the pipe and adjust the location of the torch assembly around the pipe when the weld head assembly is attached to the pipe.

### CROSS REFERENCE TO RELATED APPLICATION

This application claims the benefit of U.S. Provisional Application No. 60/803,103, filed May 24, 2006.

### FIELD OF THE INVENTION

This invention relates generally to welding systems, and more particularly to precision welding systems for use in welding pipes, tubes and similar structures in confined spaces.

### BACKGROUND OF THE INVENTION

Precision welding systems are utilized for welding pipes, tubes and similar structures in confined spaces. Particular examples of confined spaces in which precision welding systems are utilized include primary cooling circuits of nuclear and fossil-fuel electric power generating plants, and fossil-fuel power boilers and heat exchangers where the need to increase heat transfer rates results in very dense pipe-to-pipe or tube-to-tube configurations which prohibit the use of conventional welding systems. The invention in its various aspects is described and explained with reference to a nuclear reactor type of electric power plant, specifically, a pressurized heavy water reactor known as a CANDU reactor. However, it is to be understood that the invention has use in many other applications and fields of use. A schematic diagram of a power generation plant having a CANDU reactor is shown in FIG. 1 of the drawings.

The CANDU reactor is a pressurized heavy water reactor developed in the late 1950s and 1960s by a partnership between Atomic Energy of Canada Limited (AECL) and the Hydro-Electric Power Commission of Ontario (now known as Ontario Power Generation), with the assistance of several private industry participants. The acronym “CANDU”, a registered trademark of Atomic Energy of Canada Limited, stands for “CANada Deuterium Uranium”. The CANDU reactor uses a deuterium oxide (heavy water) moderator and natural uranium fuel in the form of uranium dioxide (UO₂). As such, the CANDU reactor can be operated without expensive uranium enrichment facilities.

The heavy water moderator is contained in a large tank, illustrated in FIG. 2 and referred to herein as a “calandria,” that is penetrated by several hundred horizontal pressure tubes forming channels for containing the fuel. The fuel in the pressure tubes is cooled by a flow of heavy water under high pressure in the primary cooling circuit. The heavy water in the primary cooling circuit reaches approximately 290° C. The primary coolant generates steam in a secondary circuit to drive turbines that produce electrical power. The tube design means that the reactor can be refueled continuously, without shutting down, as the pressure tubes containing the fuel can be accessed individually. CANDU reactors do not need large pressure vessels commonly used in light water reactors, but instead rely on pressurization of relatively small tubes that contain the fuel. A CANDU fuel assembly consists of a bundle of 37 fuel rods; each having a length of about one-half meter and consisting of ceramic fuel pellets in zircaloy tubes plus a support structure; with 12 bundles lying end to end in a fuel channel. Control rods penetrate the calandria vertically and a secondary shutdown system is configured to inject gadolinium nitrate solution to the moderator.

The large thermal mass of the cool calandria acts as a safety mechanism. If a fuel assembly were to overheat and melt, it would be cooled in the process of changing the reactor geometry. Furthermore, due to the use of natural uranium as the fuel, the reactor cannot sustain a chain reaction if the original geometry of the fuel channel is altered in any significant manner. Heavy water coolant flows through the fuel assembly with a full-power flow rate of 1.98×10⁶ lb/h (249.5 kg/s) at an operating pressure of 1450 psi (10 Mpa), at the above-noted 290° C. From the calandria, reactor coolant is piped to four inverted U-tube recirculating steam generators. Each of the fuel assemblies can be isolated from the feedwater system, thereby allowing on-line refueling at full-power operation.

Pipes known as “feeder pipes” are a component of both nuclear and fossil-fuel steam electricity generators. In nuclear reactors such as the CANDU reactor, several hundred horizontal pressure tubes, each containing bundles of nuclear fuel, receive high temperature, high pressure heavy water cycled through the reactor core by pumps that carry the water to, and return it from, heat exchangers where steam is produced to spin a power-generating turbine. On the reactor side of these pumps, the water is carried in large pipes that branch out at headers into hundreds of feeder pipes that are connected to the ends of the pressure tubes. Inlet feeder pipes take relatively cool water from the inlet header into the pressure tubes, and outlet feeder pipes take hot water from the pressure tubes to the outlet header.

As illustrated in FIG. 3, the main components that make up the fuel channels and feeder pipes include end fittings 101; the feeder pipes 100, consisting of a first bend, a second bend and a straight section; a bolted connection; and a positioning assembly, including a yoke and a stud. The end fittings 101 are arranged perpendicular to the “E-face” of the end fittings, and the feeder pipes 100 are stacked in-between and crosswise to the end fittings. The reactor face is divided into quadrants in which the feeder pipes 100 can be oriented either vertical or horizontal. The feeder pipes 100, as is apparent from the above description, have complex geometric shapes and are relatively inaccessible. CANDU reactors have proven highly reliable and robust. Nevertheless, the feeder pipes 100 are subject to erosion and corrosion that results from the constant, high temperature, high pressure flow of heavy water through the pipes. Erosion and corrosion causes gradual thinning of the walls of the feeder pipes over time. However, this phenomenon is predictable. Thus, the feeder pipes can be replaced at points of erosion and corrosion. Replacement, however, has proven difficult due to the close spacing of the feeder pipes and interference from other reactor structures and components, as shown in FIGS. 4 and 5. The conventional method of repairing feeder pipes includes the use of electro-mechanical devices that are configured to position and move a gas tungsten arc around a cylindrical object, such as a tube or pipe, so as to join two individual feeder pipe sections or to place a metal overlay onto of the surface.

Given the geometry and close spacing of the feeder pipes, as well as interference from other piping and structures, it has previously been necessary in many cases to sacrifice other feeder pipes, which do not need repair or replacement, by cutting through successive ranks of feeder pipes to reach the feeder pipe needing repair or replacement. Once the interior feeder pipe is repaired, the sacrificed feeder pipes are then repaired, one-by-one as the repair process backs out from the interior feeder pipe. As a result, needless additional down time is experienced along with the additional expense incurred from cutting and re-welding feeder pipes not needing repair.

Existing devices and processes for carrying out these repairs consist of motor-driven actuators located on an orbital device in order to position and control the torch around the pipe or tube to be welded. Although this practice has been utilized for decades, the configuration is limited in its application due to several fundamental features that have heretofore proven difficult to improve. For example, in order to fabricate a small system, highly specialized miniature motors and gear trains must be used. Due to their size the system is limited in the amount of power it can generate and therefore is sensitive to mechanical loads. In order to protect the fragile mechanical components, some form of mechanical load-limiting feature, such as shear pins or clutches are utilized. This results in added complexity, increased cost and decreased reliability.

Furthermore, existing devices and processes are not small enough to satisfy applications requiring small working areas due to packaging constraints encountered when the devices are mounted directly on the weld head assembly. For the same reason, the available devices cannot be packaged in such a fashion as to be remotely deployed through or past space-limiting obstructions. This is a common concern that is faced when attempting to weld pipes or tubes to headers or the like when multiple pipes or tubes are in close proximity to one another. Also, when the motors and their feedback devices are located directly on the weld head assembly, they are exposed to the heat created by the welding process and therefore must be cooled. This is typically accomplished by circulating pressurized water in a jacket surrounding the heat sensitive components—adding complexity and radically reducing system reliability. The physical size of the motors and the mechanical drive systems render it impractical to fabricate compact, highly robust precision welding systems. Therefore, precision welding systems utilizing existing devices and processes are limited to applications that allow for the radial and axial space requirements of such systems.

Finally, existing devices and processes do not fully satisfy safety concerns, such as radiation exposure, which require that repairs be carried out with minimum radiation exposure to repair workers. Accordingly, a precision welding system is needed that overcomes the deficiencies of the existing devices and processes.

### SUMMARY OF THE INVENTION

The present invention provides an overall solution to the above-described problems with a precision welding system consisting of novel apparatus and process steps that include the ability to carry out an orbital cutting and/or welding process within a confined space. Specifically, the present invention provides a precision welding system configured to repair a pipe located within a plurality of closely-spaced pipes without sacrificing any of the pipes routed between the access point and the pipe to be repaired, and to perform either a semi-automatic or fully automatic precision weld process. As illustrated in FIGS. 7 and 8, and described in greater detail hereinafter, the present invention is capable of inserting a weld head assembly between a plurality of closely-spaced pipes departing from a header. As illustrated in FIG. 9 and described in greater detail hereinafter, the present invention is also capable of inserting a weld head assembly along the axial length of a pipe between adjacent closely-spaced pipes. An orbital precision welding system according to the present invention, which by way of example may be based on use of a gas tungsten arc welder, provides the electromechanical means required to orbit and position a tungsten inert gas (TIG) welding torch assembly around a cylindrical shape in order to join two sections of pipe or tube together, or to place reinforcement material above the surface of the pipe or tube. As described in further detail hereinafter, the present invention utilizes the following devices and process steps.

Torch Travel Axis—The torch travel axis is utilized to move and position the welding torch in a radial motion around the upper surface of the pipe or tube that is to be welded. Existing devices utilize one of two basic types of travel carriage mechanisms and associated methods. The first device and method involves the use of a conventional torch carriage and track assembly. The concept of this method is similar to a train car moving on a train track. Utilizing this approach, a curved track assembly is mounted onto the outer surface of the pipe or tube to be welded. Once the track is secured, a “carriage assembly” containing the motors and drive train assembly is fastened onto the track. The second device and method involves the use of a rotating “C” frame assembly. In this approach, the travel axis consists of two open “C” shaped structures designed to allow the throat of the “C” shaped structures to be slipped over the pipe or tube to be welded. Once located around the pipe or tube, one of the “C” shaped structures is affixed to the pipe or tube in such a manor as to prohibit further movement relative to the device. This first “C” shaped structure is typically referred to as the base frame or lower “C” frame assembly. It is this assembly that supports the travel motors and gear train assembly that drive the second “C” shaped structure, referred to as the upper “C” frame assembly, about the pipe or tube. In these two approaches, the travel carriage or the upper “C” frame assembly perform the following functions and support the corresponding components.

Torch Cross Seam (Oscillation) Axis—This axis is responsible for moving the torch longitudinally along the face of the pipe or tube to be welded. Utilizing the cross seam axis, the torch tip can be positioned so that various weld passes are placed adjacent to each other. This axis can also be used to weave the torch “back and forth” across the weld seam in order to spread the width of the weld bead in order to cover an increased area per weld pass. In most all cases when the first torch travel axis method described above is utilized, the torch oscillator is mounted onto the torch carriage assembly. Depending on the application, when the second torch travel axis method is utilized the torch oscillator for the torch cross seam axis can be placed between the fixed lower “C” frame assembly and the pipe, or it can be placed on the rotating gear of the upper “C” frame assembly and move with the torch height control axis and the torch block assembly.

Torch Height Axis—This axis is used to position the torch at the desired height above the pipe or tube to be welded. Typically this axis is controlled via the measurement of the arc voltage (when welding) and then compared against a desired arc voltage. If the measured arc voltage is above the desired amount, the torch height axis is commanded to move toward the surface of the pipe or tube in order to shorten the arc length, which reduces the arc voltage. If the arc voltage is less than the desired amount, the torch height axis would move away from the surface in order to increase the arc length.

Wire Feed—Depending on the gas tungsten arc weld (GTAW) process utilized, the wire feed device may be used to feed a given amount of round metallic filler material into the weld zone. In most cases the weld wire is a drawn wire having a desired metallurgical composition necessary to yield the required mechanical strength when joining two adjacent pipe or tube segments, or to overlay the pipe or tube with a material that will increase corrosion and/or abrasion resistance.

Numerous benefits are obtained from utilization of a precision welding system according to the present invention. The benefits include the ability to locate all motors, motion feedback and other electromechanical devices at a remote location so that they are not subjected to the heat of the welding process, and therefore, do not need to be cooled. Remote placement permits the motors to be enlarged sufficiently to provide ample power while utilizing industry standard low cost assemblies. Similarly, the highly simplified mechanical design of the drive train and other mechanical components can be made sufficiently large utilizing industry standard components. As a result, a precision welding system according to the present invention is considerably more robust, and is considerably more reliable and simple to service and maintain. The weld head assembly does not include any type of motor or electrical subassembly, meaning that the system is tolerant of vibration and physical shock and can be submerged for cleaning and for radiological decontamination purposes. The modular nature of the components permits the precision welding system to be physically scaled for most any diameter of pipe or tube.

It is a general object of the invention to provide a welding system for performing a welding process in confined spaces. Accordingly, the invention is embodied in one aspect by a welding system including a motor housing, a weld head assembly and an insertion tube extending between the motor housing and the weld head assembly such that the weld head assembly is remote from the motor housing. The motor housing and the insertion tube are supported on a platform for rotational and translational movement of the weld head assembly, and the motor housing houses at least one motor for positioning the weld head assembly relative to a pipe to be welded. The weld head assembly includes a clamp assembly for attaching the weld head assembly to the pipe and a weld tool assembly mounted adjacent the clamp assembly for performing the welding process on the pipe. The weld tool assembly includes a frame for supporting an arc length gear, a travel gear, and a torch assembly. The arc length gear and the travel gear cooperate to adjust the distance between the torch assembly and the pipe and to adjust the location of the torch assembly around the circumference of the pipe when the weld head assembly is attached to the pipe. In a preferred embodiment, the arc length gear and the travel gear are positioned in stacked relation and the arc length gear and the travel gear rotate relative to one another to increase and decrease the distance between the torch assembly and the pipe. Conversely, the arc length gear and the travel gear rotate together to move the torch assembly around the circumference of the pipe.

It is a more specific object of the invention to provide a precision welding system that can access a feeder pipe between closely-spaced feeder pipes of a reactor. Accordingly, the invention is embodied in another aspect by a weld head assembly for a welding system adapted for performing a welding process on a pipe in a confined space. The weld head assembly includes a clamp assembly for attaching the weld head assembly to the pipe and a weld tool assembly mounted adjacent the clamp assembly for performing the welding process on the pipe. The clamp assembly includes clamping jaws having a plurality of fingers that make contact with the pipe to attach the weld head assembly to the pipe and a cross-seam axis assembly for providing linear adjustment of the weld head assembly in an axial direction along the pipe. In a preferred embodiment, the cross-seam axis assembly includes a lead screw assembly operably coupled to a drive shaft for driving a pair of pivot bars pivotally attached to the weld tool assembly. The weld tool assembly has a frame for supporting an arc length gear, a travel gear, and a torch assembly. The arc length gear and the travel gear cooperate to adjust the distance between the torch assembly and the pipe and to adjust the location of the torch assembly around the circumference of the pipe when the weld head assembly is attached to the pipe. In a preferred embodiment, the weld tool assembly further includes at least one drive shaft operably coupled to a motor housed within a motor housing remote from the weld head assembly for moving the arc length gear and the travel gear.

It is another general object of the invention to provide a method of performing a welding process that includes a weld head assembly remote from any motor, motion-control feedback or other electromechanical device. Accordingly, the invention is embodied in yet another aspect by a method of welding a pipe in a confined space. The method includes providing a welding system including a motor housing, a weld head assembly having a clamp assembly and a weld tool assembly, and an insertion tube extending between the motor housing and the weld head assembly such that the weld head assembly is remote from the motor housing. The method further includes inserting the weld head assembly into the confined space using the insertion tube. The method further includes positioning the weld head assembly around the pipe using at least one motor housed within the motor housing. The method further includes attaching the weld head assembly onto the pipe using the clamp assembly and thereafter welding the pipe using the weld tool assembly, for example a tungsten arc gas welding torch.

### BRIEF DESCRIPTION OF THE DRAWINGS

The invention may be best understood by reference to the following detailed description in conjunction with the accompanying drawing figures in which:

FIG. 1 is a schematic diagram of a power generation plant having a CANDU reactor;

FIG. 2 is a perspective view of a calandria for the CANDU reactor of FIG. 1;

FIG. 3 is a side view of the reactor face showing a plurality of vertical feeder pipes for use with the CANDU reactor of FIG. 1;

FIG. 4 is an end view of the reactor face showing horizontal feeder pipes for use with the CANDU reactor of FIG. 1;

FIG. 5 is a top view of the horizontal feeder pipes of FIG. 4;

FIG. 6 is a perspective view of a precision welding system according to a preferred embodiment of the invention;

FIG. 7 is an elevation view illustrating the welding system of FIG. 6 being inserted between a plurality of feeder pipes;

FIG. 8 is a top plan view illustrating the welding system of FIG. 6 being inserted between a plurality of feeder pipes;

FIG. 9 is an elevation view illustrating the welding system of FIG. 6 being inserted between adjacent feeder pipes along the axial length of the feeder pipes;

FIG. 10 is a perspective view of a weld head assembly connected to an insertion tube of the welding system of FIG. 6;

FIG. 11 is a top perspective view of a right-hand weld head assembly of the welding system of FIG. 6;

FIG. 12 is a top perspective view of a left-hand weld head assembly of the welding system of FIG. 6;

FIG. 13 is a bottom perspective view of the weld head assembly of FIG. 12;

FIG. 14 is a top perspective view of a weld tool assembly of the weld head assembly of FIG. 12;

FIG. 15 is an exploded view of the weld head assembly of FIG. 11;

FIG. 16 is an exploded view of a portion of the weld tool assembly of FIG. 14;

FIG. 17 is a front perspective view of a clamp assembly of the weld head assembly of FIG. 12;

FIG. 18 is a rear perspective view of the clamp assembly of FIG. 17;

FIG. 19 is a perspective view of a torch assembly of the weld head assembly of FIG. 12;

FIG. 20 is a front perspective view illustrating the weld head assembly of FIG. 12 attached to a feeder pipe;

FIG. 21 is a rear perspective view illustrating the weld head assembly of FIG. 12 attached to the feeder pipe;

FIG. 22 is a top plan view illustrating the weld head assembly of FIG. 12 attached to the feeder pipe and shown with a torch assembly positioned away from the feeder pipe prior to welding;

FIG. 23 is a top plan view illustrating the weld head assembly of FIG. 12 attached to the feeder pipe and shown with a torch assembly positioned adjacent the feeder pipe during welding;

FIG. 24 is a perspective view illustrating two feeder pipe sections prior to being joined together;

FIG. 25 is a perspective view illustrating the two feeder pipe sections of FIG. 24 being positioned in alignment with one another;

FIG. 26 is a perspective view illustrating the two feeder pipe sections of FIG. 24 being tack welded together;

FIG. 27 is an elevation view showing a portion of the weld head assembly of FIG. 11 separated from the remainder of the weld head assembly;

FIG. 28 is an end view illustrating the placement of the tack welds on the pipe sections of FIG. 26;

FIG. 29 is a detail view illustrating one of the tack welds of FIG. 28;

FIG. 30 is a detail view illustrating a series of weld passes on the pipe sections of FIG. 26; and

FIG. 31 is another detail view illustrating a series of weld passes on the pipe sections of FIG. 26.

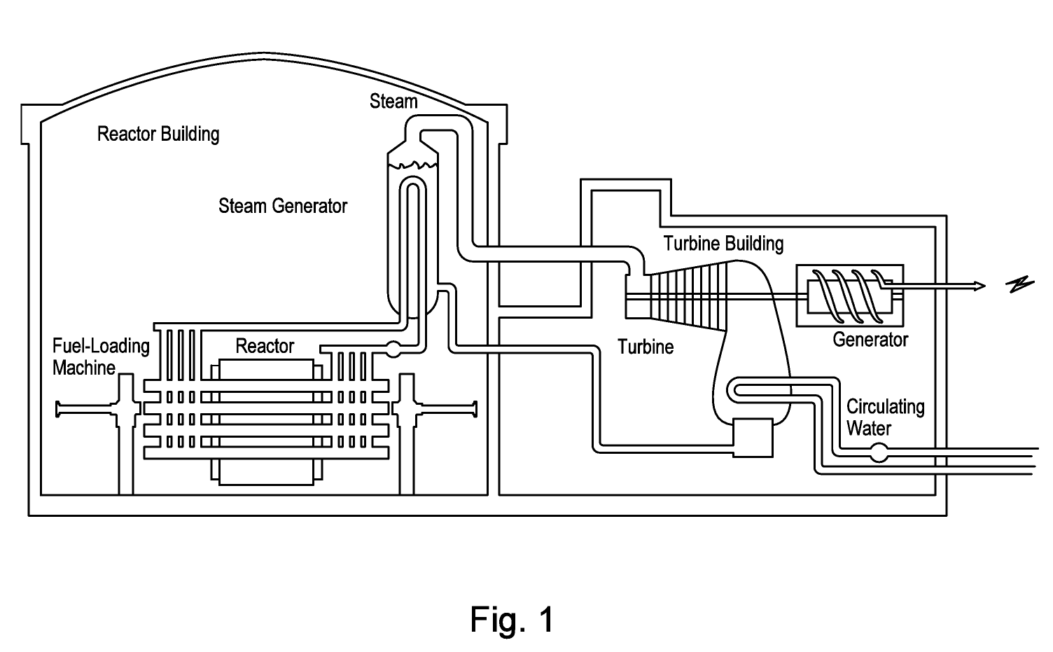

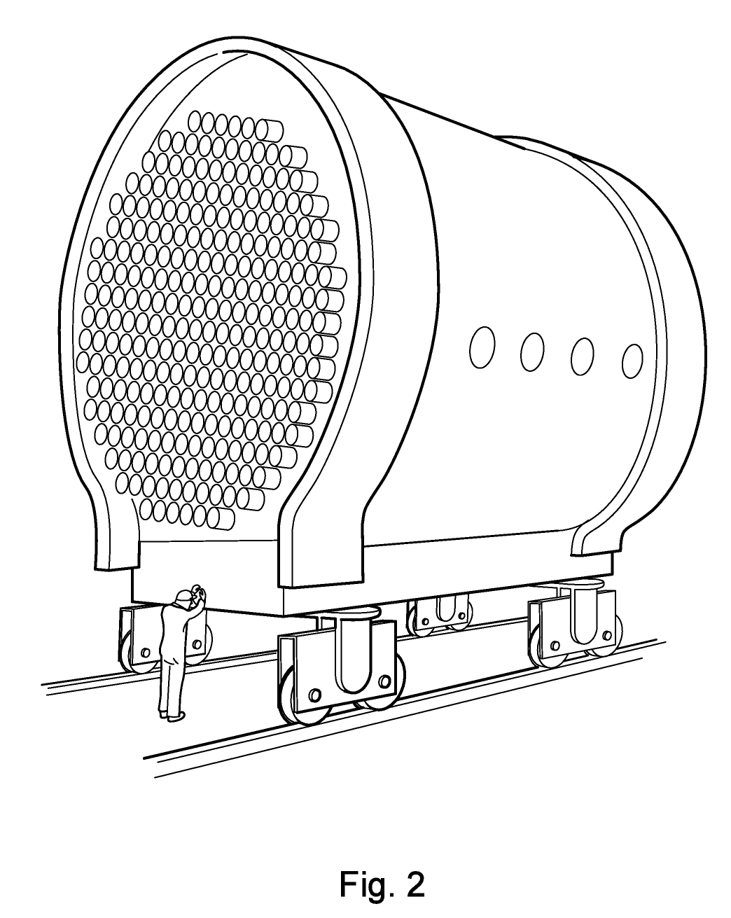

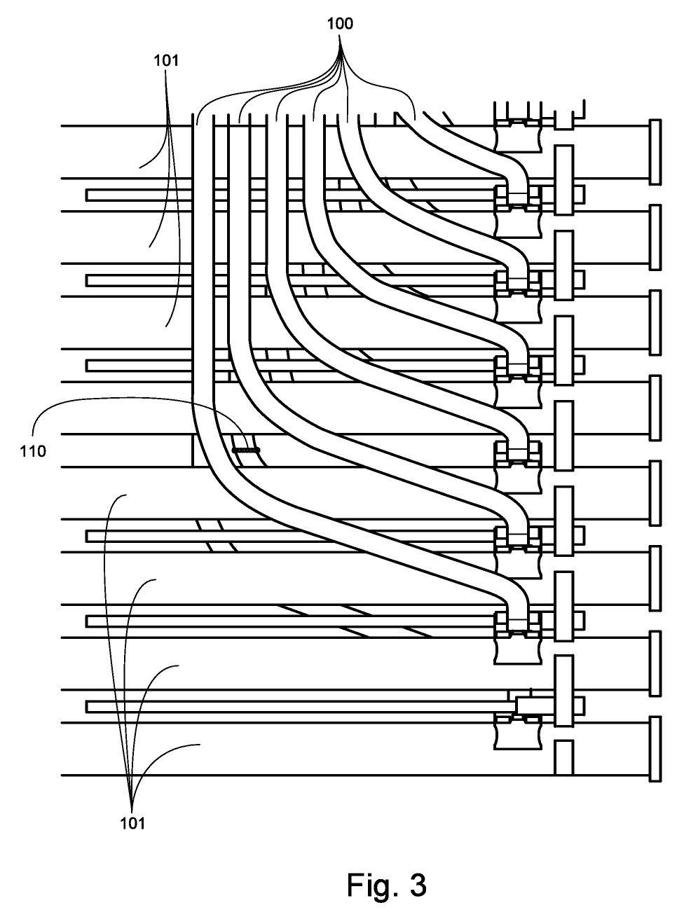

### DETAILED DESCRIPTION OF PREFERRED EMBODIMENTS OF THE INVENTION

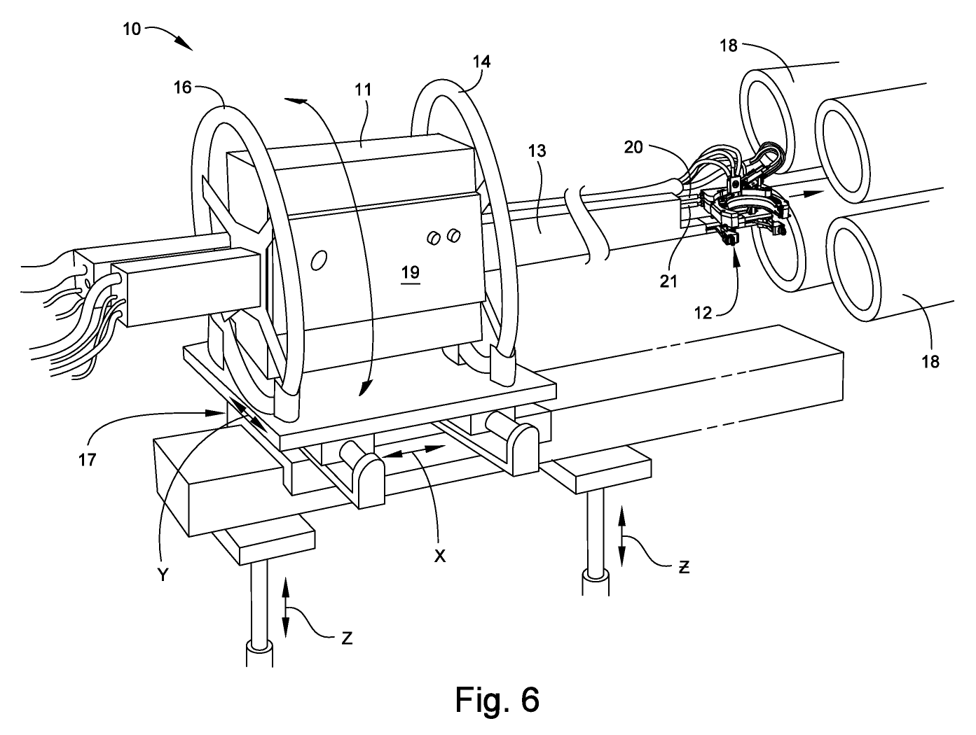

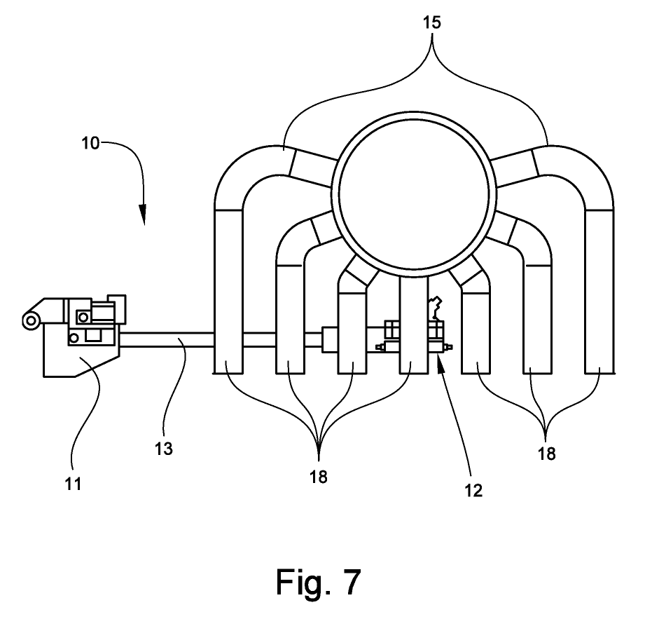

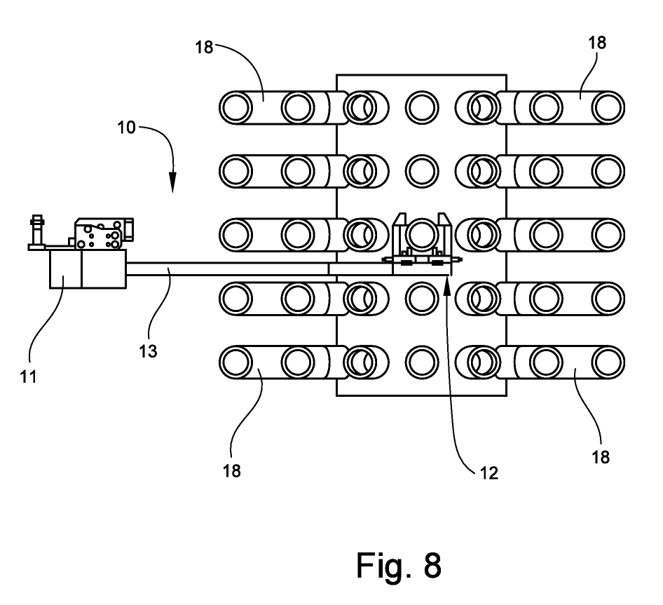

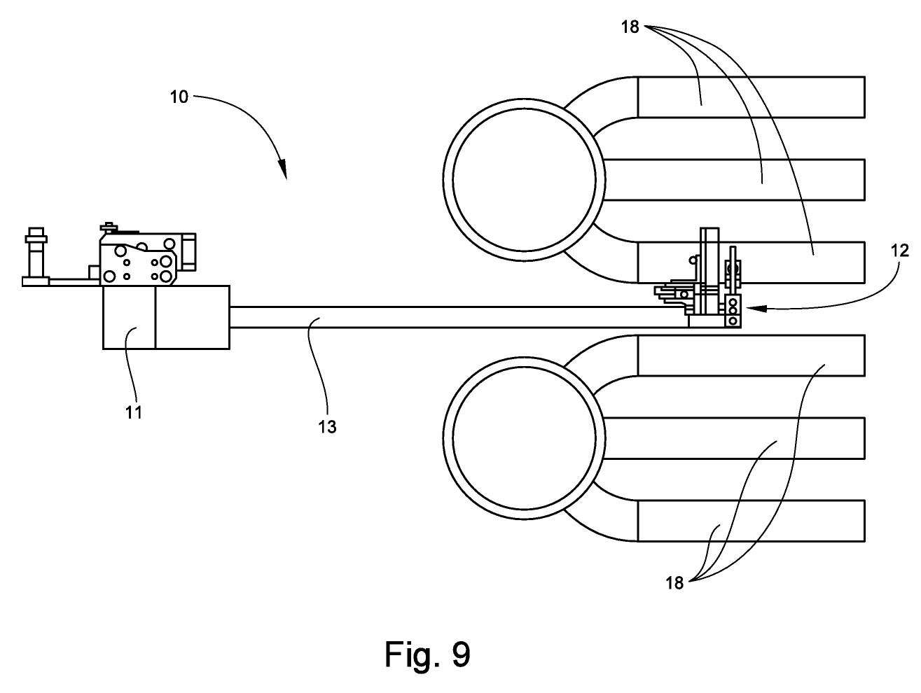

Referring now specifically to the drawings, a precision welding system according to a preferred embodiment of the invention is illustrated in FIG. 6 and indicated generally at reference numeral 10. The welding system 10 includes a motor housing 11, a weld head assembly 12 remote from the motor housing 11, and an insertion tube 13 interconnecting the weld head assembly and motor housing. Housing supports 14 and 16 are positioned on opposing ends of the motor housing 11 to allow the welding system 10 to rotate about a longitudinal axis. The supports 14 and 16 are rotatably attached to a platform 17 that allows the welding system 10 to move, in addition to rotating, in X, Y, and Z directions. As shown, the combination of the supports 14, 16 and platform 17 allow the weld head assembly 12 to be positioned for insertion into a confined space between pipes, for example feeder pipes 18 of a CANDU reactor. As illustrated in FIGS. 7 and 8, the weld head assembly 12 may be inserted between a plurality of vertical feeder pipes 18 as they depart a header 15, or, as illustrated in FIG. 9, the weld head assembly 12 may be inserted axially along the length of a horizontal feeder pipe 18 typical of high temperature gas heat exchangers utilized in combined cycle power generation facilities.

A self-contained, environmentally sealed operator station (not shown) is positioned remote from and operably connected to the motor housing 11 to control all aspects of the precision welding process. The operator station includes an operator interface and plasma display monitor; dual microprocessor control for vision and weld systems; operating systems and software; process control, data acquisition and general operation; a battery backup system; a cooling air filtration system; a shielding gas supply; a cooling water circulation system; and a power supply. The battery backup system is configured to power all critical systems in the event of a loss of power. The battery backup system provides sufficient time to safely terminate the welding process; ensure that the data acquisition and vision systems remain active; and provide the power required to position the weld head assembly 12 for removal.

The motor housing 11 houses stepper motors (not shown), a camera system, integrated control boards, and a wire feed assembly. A manual control (not shown) for clamping the weld head assembly 12 to a pipe or tube is positioned along the insertion tube 13 at the end of the motor housing 11 remote from the weld head assembly. Additionally, an access panel 19 is provided to access the stepper motors and drive shafts 20, 21 connected between the stepper motors and the weld head assembly 12 for manual retraction of the weld head assembly in the event of a power loss or system failure.

The motor housing 11 also houses an automatic cable management assembly (not shown) that ensures that a proper amount of cable is deployed to the weld head assembly 12, and to ensure that the cable does not interfere with surrounding structures, such as the pipes being welded or other mechanical devices. The cable management assembly includes a rail and carriage assembly (not shown) located in the motor housing 11, a wire feed reel (not shown), a drive assembly (not shown), and a cable trough assembly (not shown). The wire feed reel, drive assembly, and cable trough assembly are coupled to the carriage assembly. The carriage assembly is driven by a mechanical connection to a travel motor assembly to deploy a proper amount of cable through the cable trough assembly as the weld head assembly 12 traverses the pipe. The cable management assembly deploys and retracts the cable to maintain approximately a one-half inch gap between the pipe and the cable without human intervention.

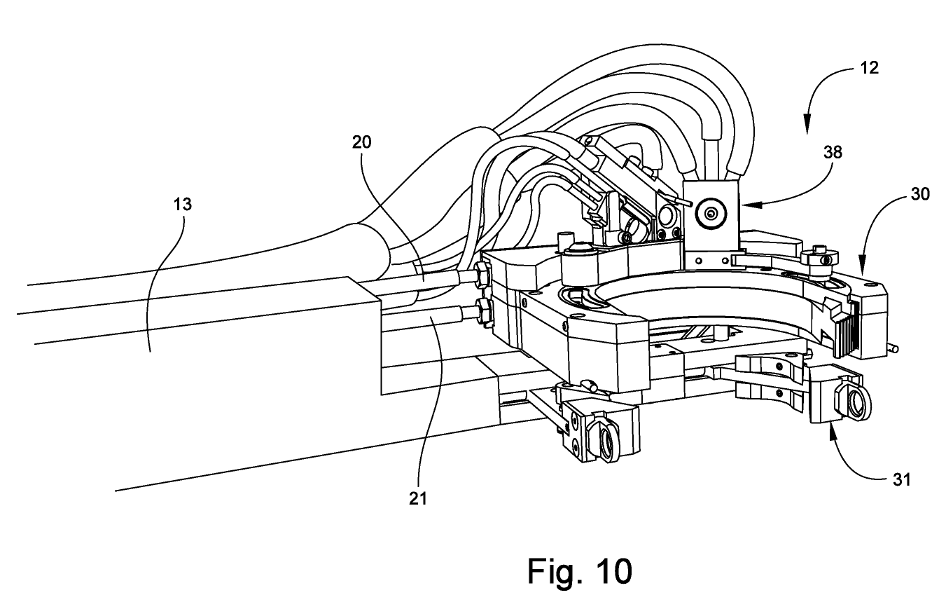

Referring to FIG. 10, the insertion tube 13 is used to deliver the weld head assembly 12 and all cabling required for its operation to a weld location. The insertion tube 13 may be of various lengths to access different weld locations and may be attached to either end of the motor housing 11 to provide a welding system 10 that allows both left-hand and right-hand orientation. The insertion tube 13 is hollow and houses drive shafts 20 and 21, all electrical cables, gas hoses, and coolant lines that are required for operation of the weld head assembly 12. As shown, the weld head assembly 12 is fixed to an end of the insertion tube 13.

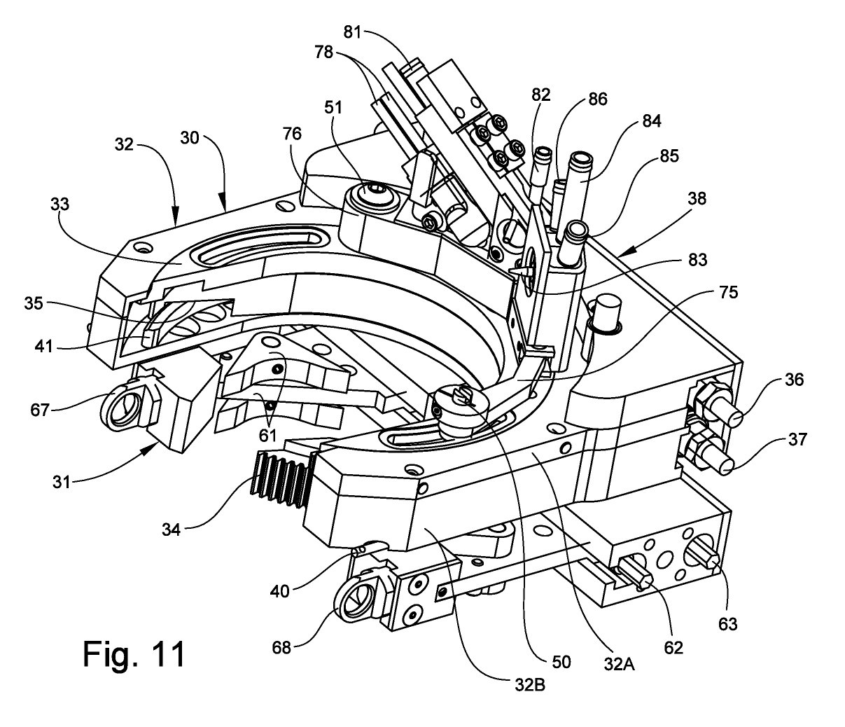

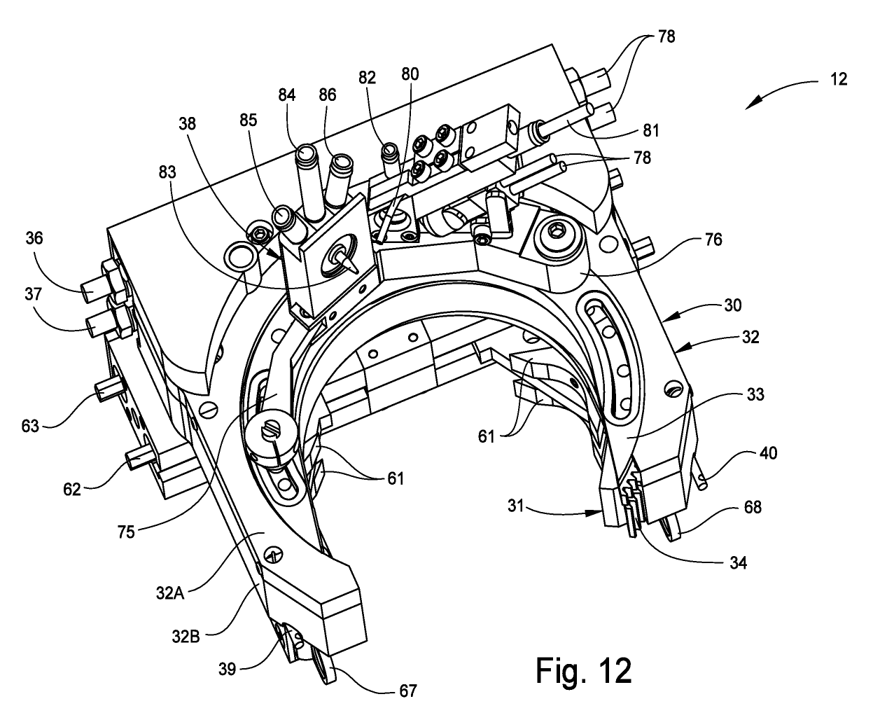

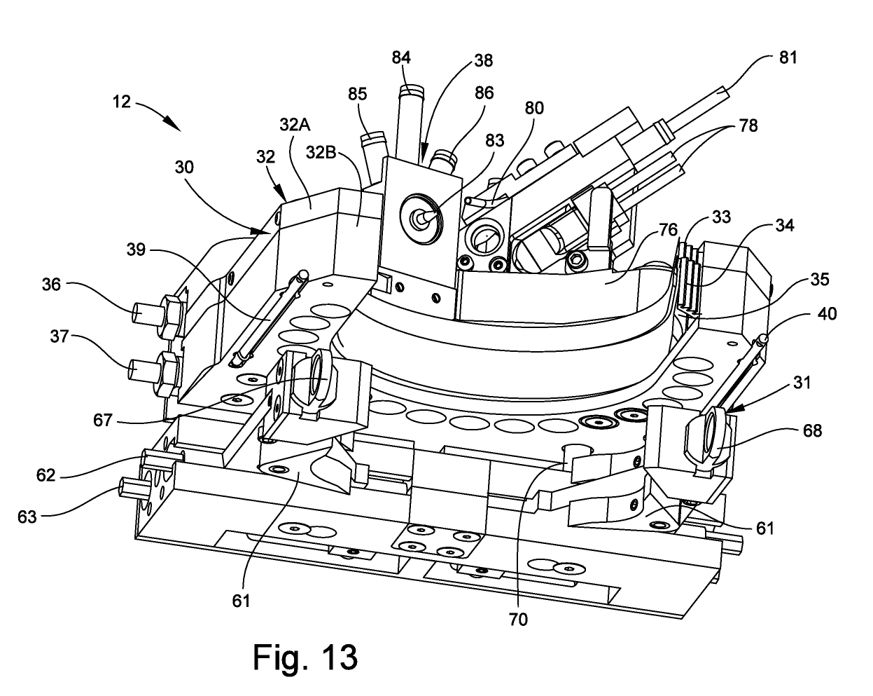

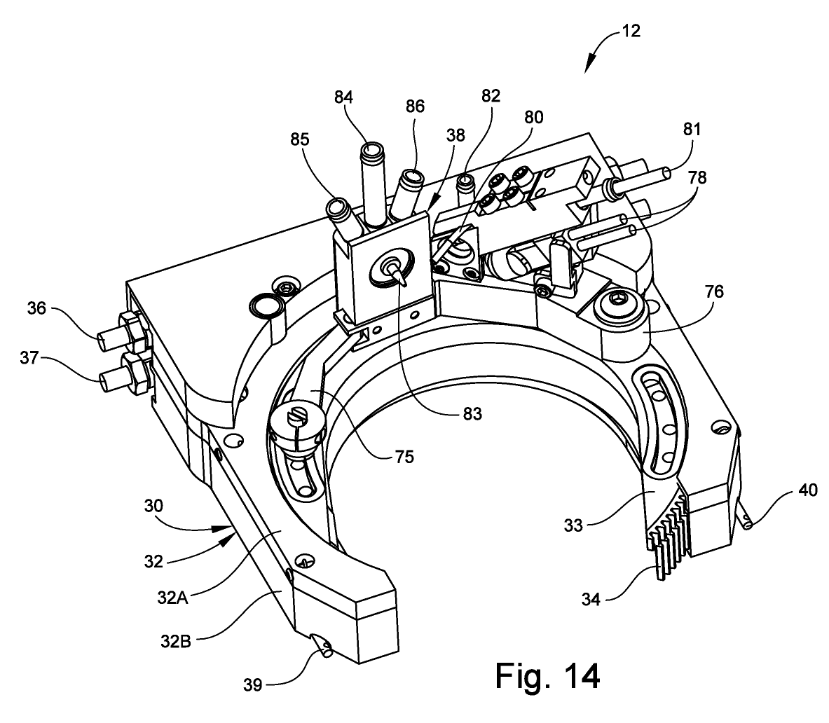

Referring to FIGS. 11-15, the weld head assembly 12 may have a right-hand orientation, as shown in FIG. 11, or a left-hand orientation, as shown in FIG. 12, to correspond to the orientation of the insertion tube 13, and thereby provide an asymmetric welding system. The weld head assembly 12 includes a weld tool assembly 30 and a clamp assembly 31. As best shown in FIG. 13, the clamp assembly 31 is mounted beneath the weld tool assembly 30. The weld tool assembly 30 includes a C-shaped frame 32 having an upper frame plate 32A and a main frame housing 32B for supporting an arc length gear 33, a travel gear 34, drive shafts 36 and 37, and a torch assembly 38. Separation pins 39 and 40 are provided to allow the weld head assembly 12 to be dismantled in the event of a jam. While the weld head assembly 12 is being described with reference to a torch assembly 38 for precision welding, it should be appreciated that other tools, such as a grinder, may be used with the weld head assembly in a similar manner.

The arc length gear 33 and travel gear 34 are in stacked relation with each other and cooperate to adjust the distance between the torch assembly 38 and a pipe to be welded, as well as the location of the torch assembly around the circumference of the pipe. As shown, a bottom face of the arc length gear 33 cooperates with a top face of the travel gear 34 to allow the gears to move relative to each other within the frame 32. A radial travel rail assembly 41 (FIG. 11) is nested within the frame 32 and interacts with a slot 35 formed in the bottom of the travel gear 34 to allow the arc length gear 33 and travel gear to rotate radially around the pipe. Radial bearings may also be used in place of the rail assembly 41 to allow the arc length gear 33 and travel gear 34 to rotate radially around the pipe. The arc length gear 33 and travel gear 34 may rotate simultaneously or separately around the pipe.

As best shown in FIG. 16, drive shafts 36 and 37 are operably coupled to drive shafts 20 and 21. Stepper motors (not shown) mounted in the motor housing 11 apply force to the drive shafts 36 and 37 via coupled drive shafts 20 and 21. Worm gears 42 and 43 are provided on the drive shafts 36 and 37, respectively, to rotate individual gear train assemblies 44 and 46. Gear train assembly 44 drives arc length gear 33 and gear train assembly 46 drives travel gear 34.

The torch assembly 38 is secured to both the arc length gear 33 and the travel gear 34. A pivot post 50 secures the torch assembly 38 to the arc length gear 33 and a guide post 51 extends through a slot 52 in the arc length gear and is secured to the travel gear 34. This configuration allows the torch assembly 38 to be moved inwardly (towards) or outwardly (away from) the pipe to control and maintain a proper arc length between the pipe and the torch assembly during the welding process. For example, if the arc length gear 33 and travel gear 34 move together there is no change in arc length between the torch assembly 38 and the pipe. However, if the arc length gear 33 does not move and the travel gear 34 rotates clockwise, the guide post 51 slides within slot 52 to move the torch assembly 38 outwardly from the pipe, thereby increasing the arc length. Conversely, if the travel gear 34 does not move and the arc length gear 33 rotates clockwise, the guide post 51 slides within the slot 52 to move the torch assembly 38 inwardly towards the pipe, thereby decreasing the arc length. A reference voltage, such as 9 volts, is used to determine when a variation in the arc length occurs between the torch assembly 38 and the pipe. When a variation is detected, the arc length gear 33 adjusts the position of the torch assembly 38 by either leading the travel gear 34 (decreasing the arc length) or lagging behind the travel gear (increasing the arc length).

The weld head assembly 12 also includes a thermocouple to monitor temperature during the welding process and encoders to provide position and velocity feedback to maintain a consistent arc length between the torch assembly 38 and the pipe.

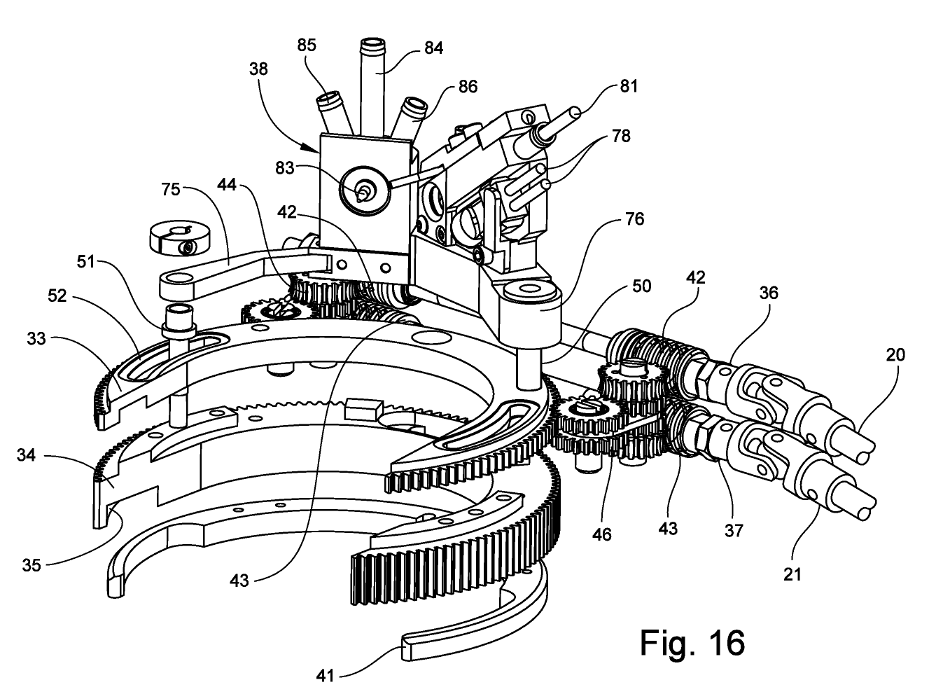

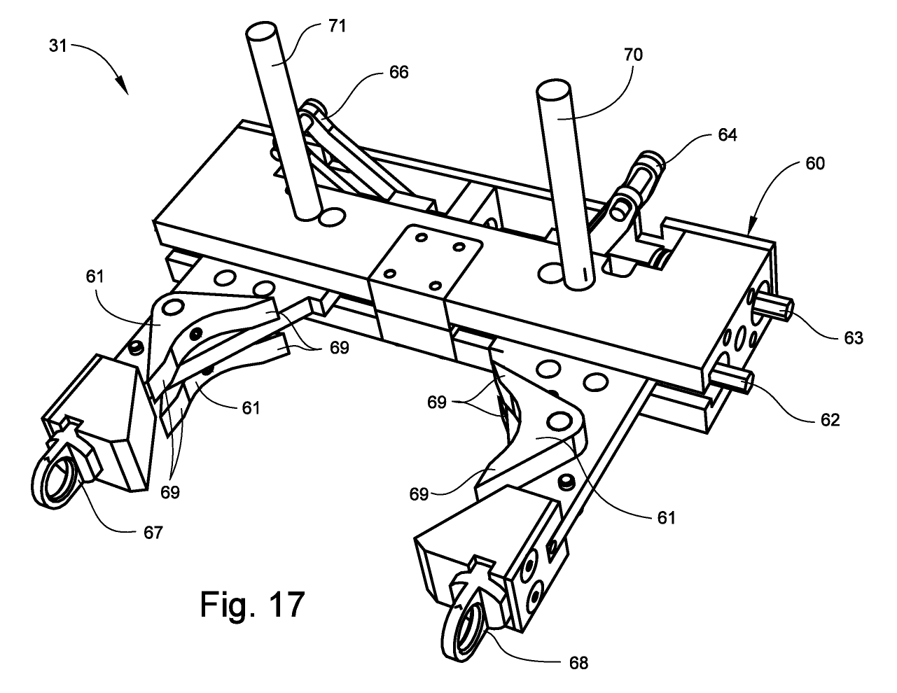

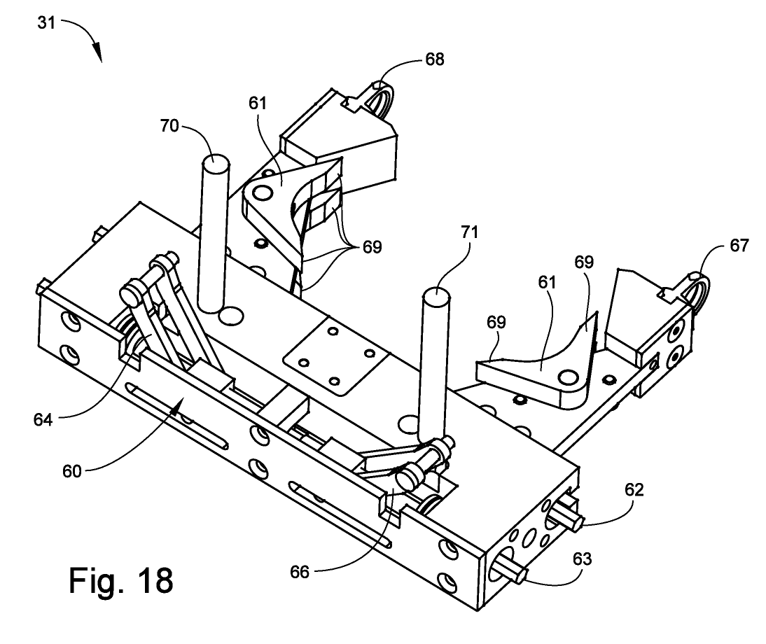

Referring to FIGS. 17 and 18, the clamp assembly 31 includes a cross-seam axis assembly 60 and a set of clamping jaws 61 that hold the weld tool assembly 30 on and in alignment with a pipe being welded. The clamping jaws 61 are manually operated via a lead screw assembly 62, and have a shape configured to accommodate some out-of-roundness in the pipe. As shown, each of the clamping jaws 61 have fingers 69 that make contact with the pipe, resulting in eight points of contact. Release pins are 67 and 68 are provided to release the clamp assembly 31 in the event of a loss of power or system failure. The cross-seam axis assembly 60 provides linear adjustment of the weld head assembly 12 in the axial direction along the pipe to ensure that the torch assembly 38 can reach the outer edges of a weld location without the need to relocate the weld tool assembly 30 on the pipe.

An oscillation lead screw assembly 63 is mounted within the cross-seam axis assembly 60, and is operably coupled to a drive shaft (not shown) that runs through the insertion tube 13. A stepper motor mounted within the motor housing 11 provides power to that drive shaft. An encoder is used to provide position and velocity feedback in a conventional manner. The lead screw assembly 63 drives a pair of pivot bars 64 and 66 pinned to the frame 32. The pivot bars 64 and 66 translate along the lead screw assembly 63 to move the frame 32 along guide posts 70 and 71 to position the torch assembly 38 over the weld location. The guide posts 70 and 71 are fixed to the cross-seam axis assembly 60.

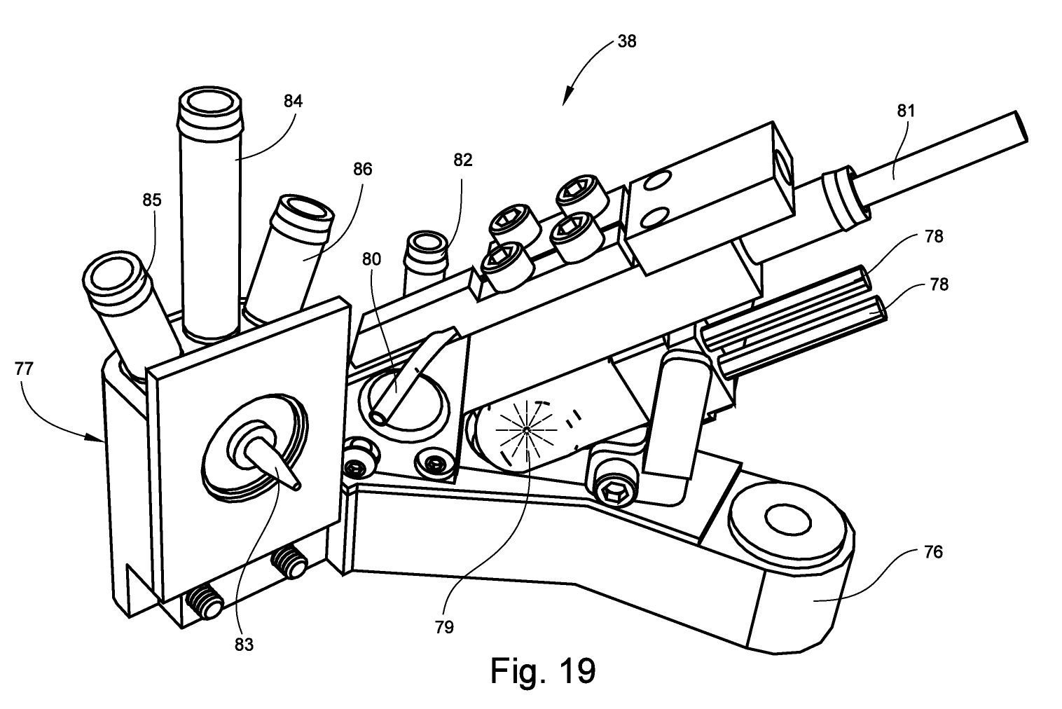

As shown in FIG. 19, the torch assembly 38 includes a pivot bracket 76, a water-cooled torch block assembly 77 mounted to the pivot bracket 76, a fiber optic vision system 78 including a light source 79 to provide alignment and inspection images of the weld joints, a wire feed 80, cooling air feed 81, and cooling air return 82. The torch block assembly 77 includes a gas tungsten arc welding torch 83, a weld gas feed 84, a cooling water input 85, and a cooling water return 86. A pivot arm 75 (FIG. 16) connects the pivot bracket 76 to the guide post 51. As previously discussed with reference to FIG. 16, when the arc length between the pipe and the torch assembly 38 is adjusted, the arc length gear 33 and travel gear 34 rotate relative to one another to increase or decrease the arc length. If the arc length is decreased by moving arc length gear 33 clockwise and holding travel gear 34 in position, the distance between post 51 and post 50 increases, causing pivot arm 75 and pivot bracket 76 to draw the torch 83 towards the pipe. If the arc length is increased by moving the travel gear 34 clockwise and holding the arc length gear 33 in position, the distance between the posts 50 and 51 decreases, causing the pivot arm 75 and pivot bracket 76 to drive the torch 83 away from the pipe.

The vision system 78 provides a leading view of the pipe; wire entrance position; weld pool; and torch tip during the welding process and allows visual inspections of the weld after each pass. The view from the vision system 78 is processed and filtered by a vision and data acquisition controller (not shown) before it is recorded and displayed. The wire feed 80 is a push-pull type wire system to accurately feed wire over a long distance. A wire manipulator (not shown) may be mounted alongside the torch block assembly 77 to allow for manual adjustment of the axis of the wire in relation to the torch 83.

A flow sensor is utilized in the weld gas feed 84 to monitor flow of the weld gas to the torch block assembly 77. If the weld gas flow drops below a preset level, all welding operations including power supplied to the torch 83 is terminated. A flow sensor is also utilized in the cooling water input 85 to monitor flow to the torch block assembly 77. If the water flow drops below a preset level, all welding operations including power to the torch 83 are terminated. Power to the torch 83 is not restored until the fault condition is corrected and the system is reset.

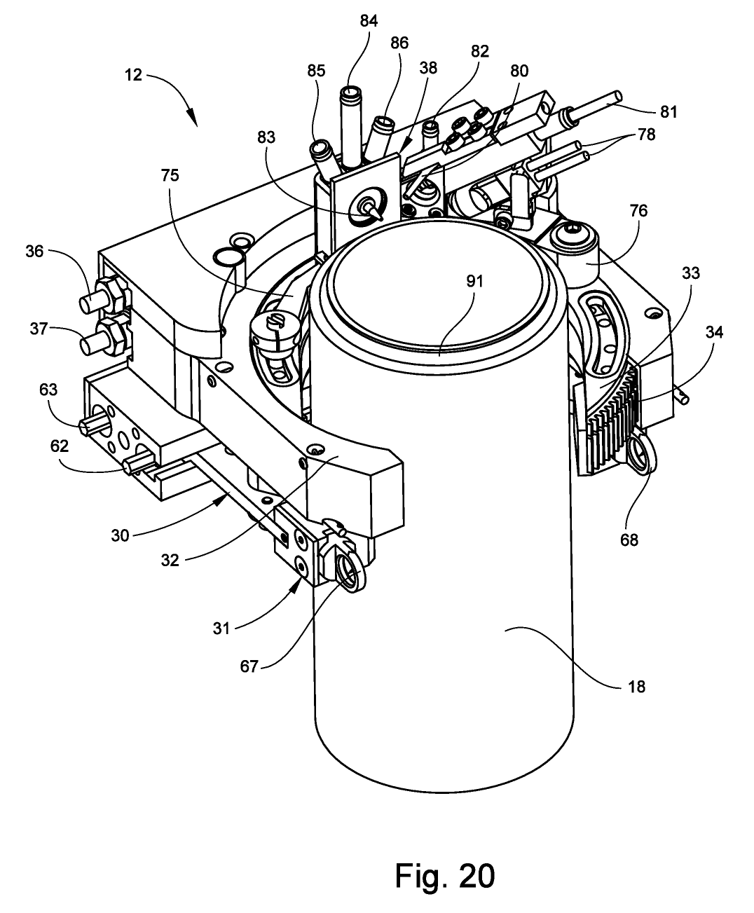

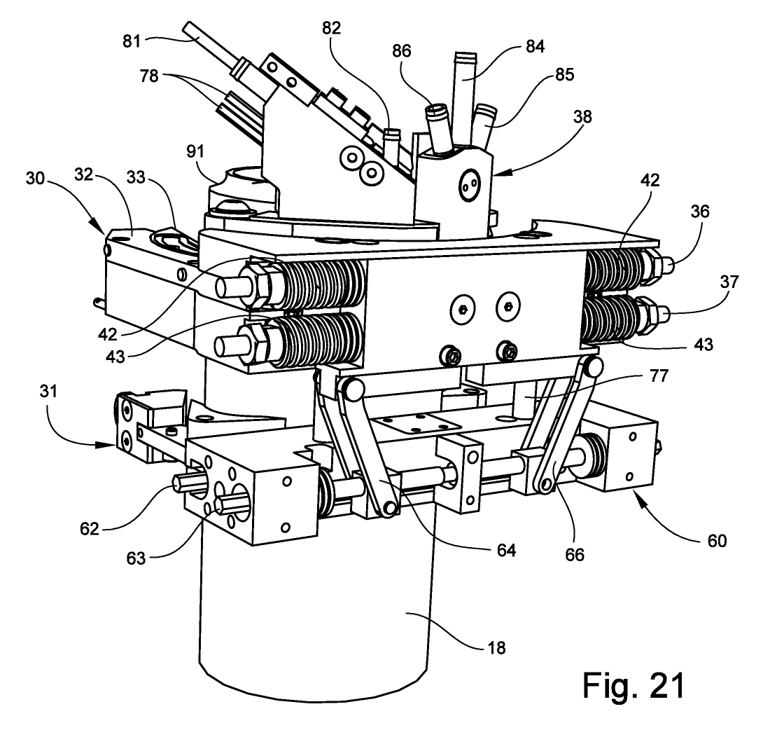

As shown in FIGS. 20 and 21, the weld head assembly 12 is attached to a pipe, for example a feeder pipe 18 of a reactor, by the clamp assembly 31 at a position to allow the weld tool assembly 30 to perform a welding operation. As shown in FIG. 21, the pivot bars 64 and 66 have been translated along the lead screw assembly 63 to a middle position so that the torch 83 is aligned axially with a weld area 91 that has been prepared for welding to the end of an adjacent pipe.

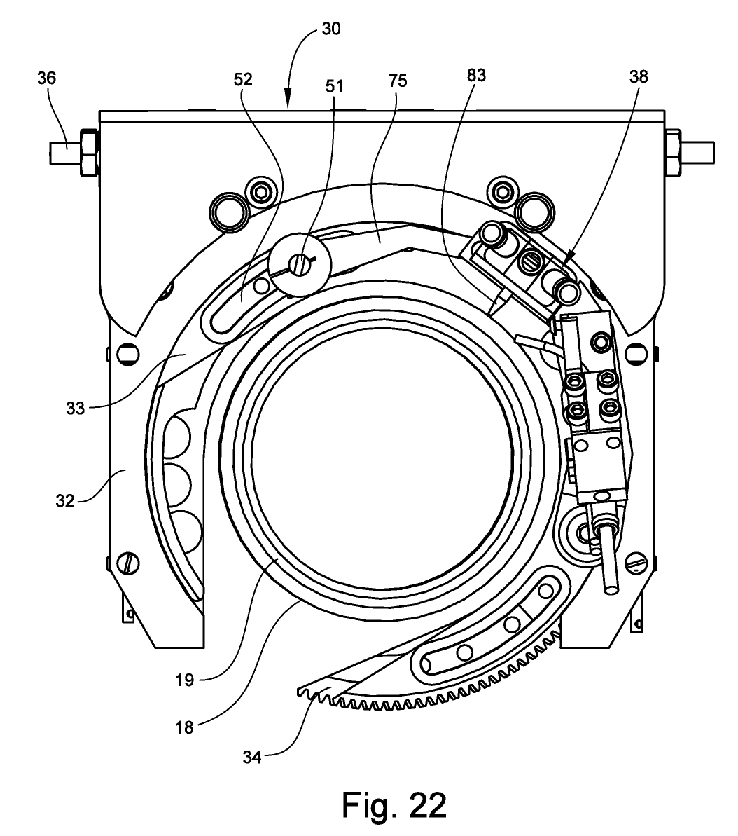

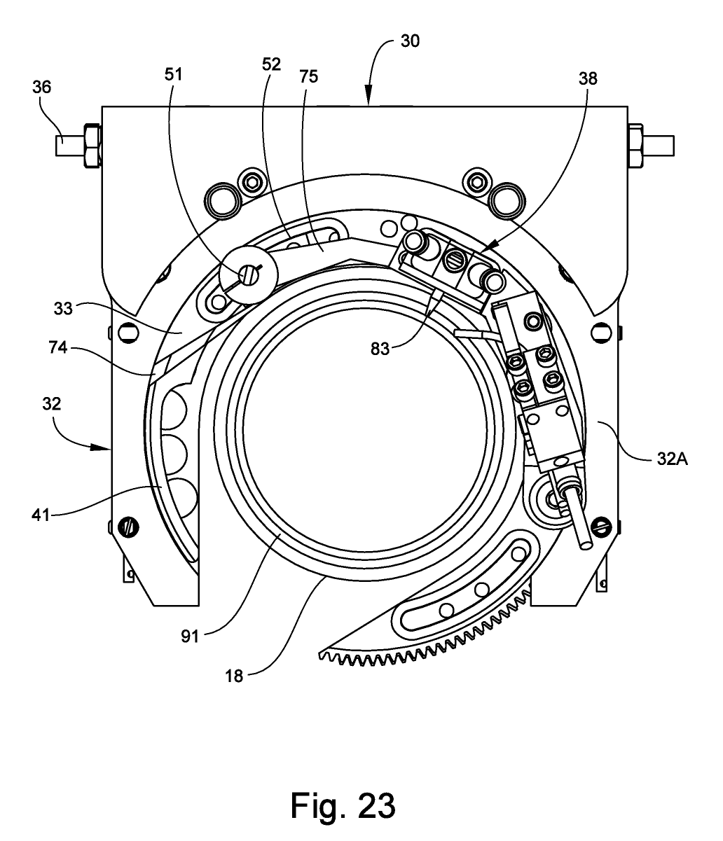

Referring to FIGS. 22 and 23, torch assembly 38 may be moved inwardly (towards) and outwardly (away from) the pipe 18 to maintain a suitable arc length therebetween before and during operation. As shown in FIG. 22, the torch assembly 38 is positioned away from the weld area 91 prior to welding. In this case, the arc length gear 33 is lagging the travel gear 34 (i.e. the travel gear is rotated clockwise relative to the arc length gear) and the guide post 51 is positioned nearer the right-hand side of the slot 52. In FIG. 23, the torch assembly 38 has been moved to a welding position. In this case, the arc length gear 33 is leading the travel gear 34 (i.e. the arc length gear is rotated clockwise relative to the travel gear) and the guide post 51 is positioned nearer the left-hand side of the slot 52.

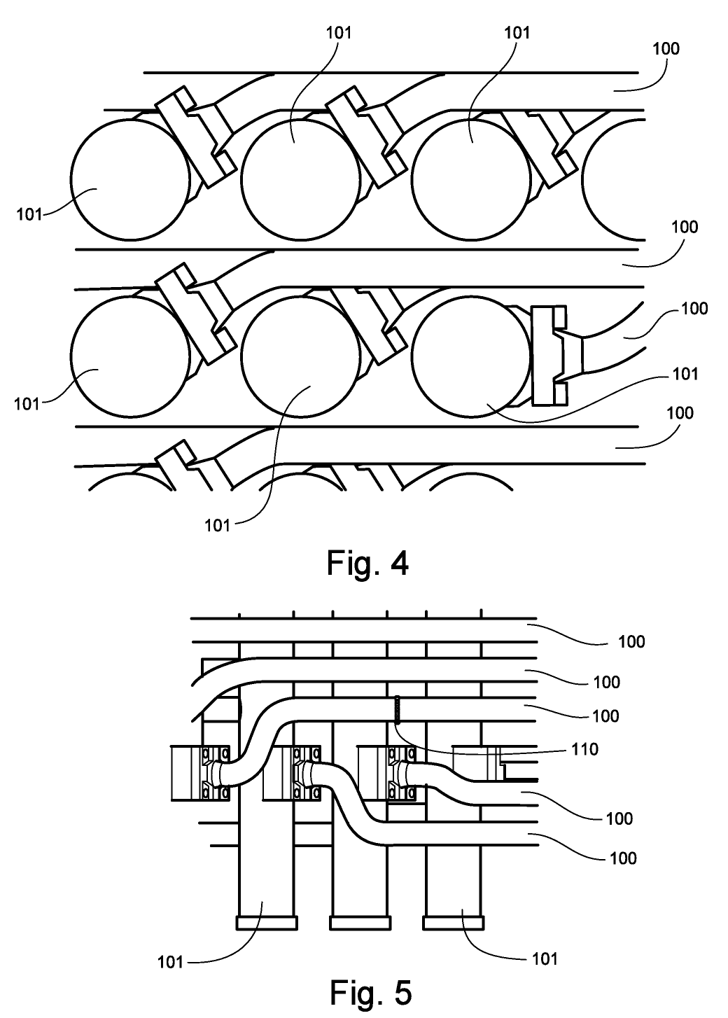

The operation of the welding system 10 will be discussed below with reference to a CANDU reactor. It should be appreciated that the welding system 10 is not limited to use with CANDU reactors and may be used generally to join any two sections of tube or pipe together. As shown in FIGS. 4 and 5, a CANDU reactor includes a plurality of feeder pipes 100 connected to a plurality of end fittings 101. The feeder pipes 100 are run in the same horizontal plane and are run substantially parallel to one another, resulting in several rows of feeder pipes. Further, the end fittings 101 are stacked in a plurality of vertical rows. The arrangement of the end fittings 101 and the feeder pipes 100 produces an extremely confined space for accessing a weld location on a feeder pipe that is positioned several rows back into the reactor.

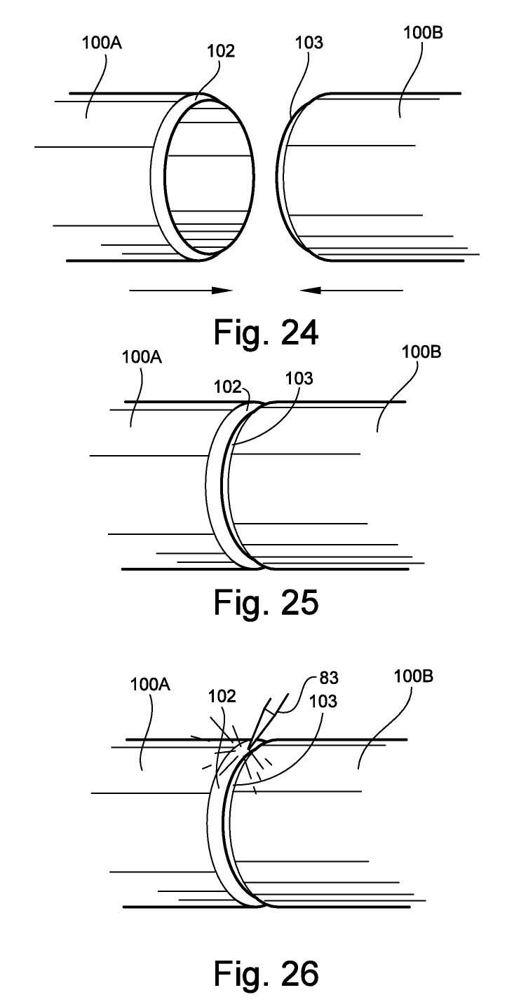

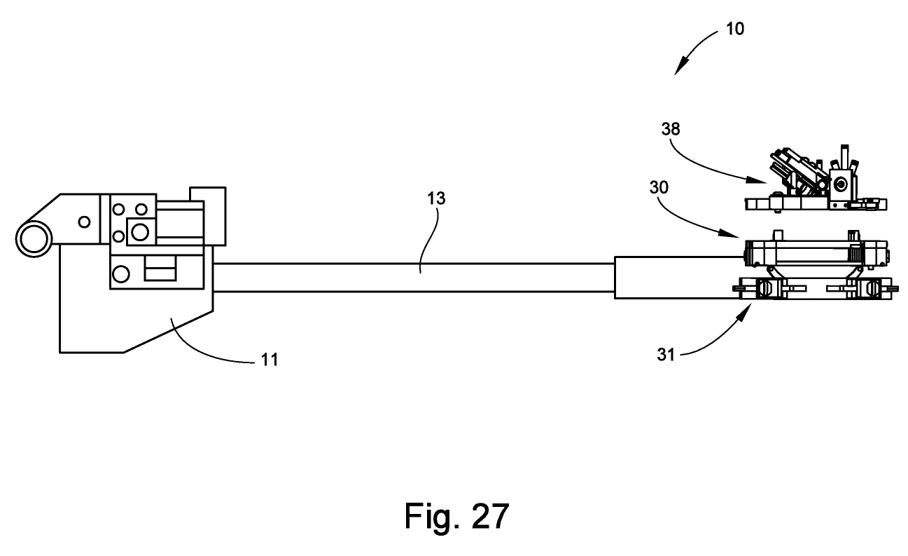

As illustrated in FIGS. 24 and 25, a welding process is performed on a damaged feeder pipe 100 by first aligning two prepared feeder pipe sections 100A and 100B in an end-to-end relation. The welding system 10 is then positioned in front of the face of the reactor, as shown in FIG. 6, for insertion of the weld head assembly 12 into the confined space between the end fittings 101 and the feeder pipes 100. Once the welding system 10 is properly positioned, the weld head assembly 12 is inserted and advanced into the confined space until the weld head assembly 12 is positioned over the weld location 110. During the insertion process, the weld head assembly 12 can be rotated to clear other feeder pipes 100, end fittings 101, headers, and other pipes or structures using the supports 14 and 16. Once the weld head assembly 12 is positioned over the weld location 110 (shown on the third feeder pipe 100 from the top in FIG. 5), the weld head assembly is rotated until the opening of the weld head assembly is positioned over the feeder pipe. The weld head assembly 12 is then slid onto the feeder pipe 100. As shown in FIG. 27, in the event that the confined space is too small for the entire weld head assembly 12 to be inserted, the weld head assembly may be separated and installed as two separate components. In this instance, the torch assembly 38 is removed from the frame 32, allowing the frame and clamp assembly 31 to be inserted into the confined space and installed onto the feeder pipe 100. The torch assembly 38 is then inserted into the confined space and re-installed onto the frame 32.

The cross-seam axis assembly 60 is then centered over the feeder pipe sections 100A, 100B utilizing video feedback. Once centered, the weld head assembly 12 is attached on feeder pipe section 100A, in the case of a weld head assembly having a right-hand orientation, by the clamp assembly 31 tightening the clamping jaws 61 using the manual control located on the end of the motor housing 11. The axial alignment of the two feeder pipe sections 100A, 100B is then verified and the torch assembly 38 is rotated 360 degrees around the feeder pipe section 100A to probe a weld area 102. The torch assembly 38 is then rotated 360 degrees in the opposite direction around the feeder pipe section 100B to probe a weld area 103. A master computer system determines the degree of alignment of the two feeder pipe sections 100A, 100B. If the feeder pipe sections 100A, 100B are not sufficiently aligned, the weld head assembly 12 is removed and the feeder pipe sections are realigned.

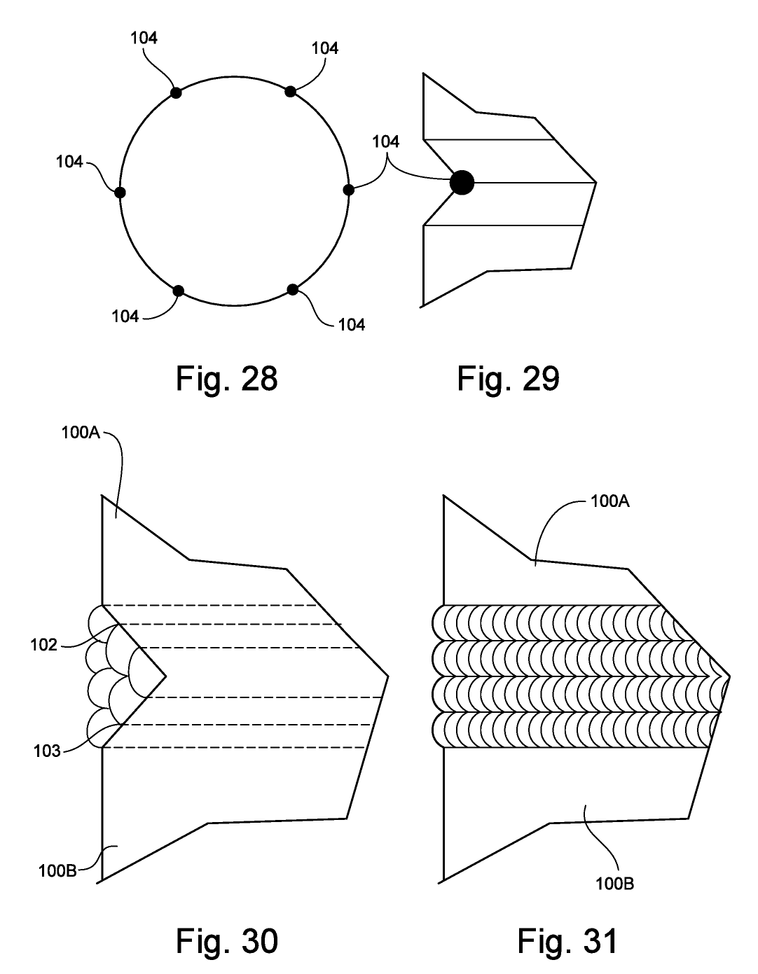

Referring to FIGS. 26, 28, and 29, once the feeder pipe sections 100A, 100B are sufficiently aligned and the weld head assembly 12 is locked onto feeder pipe section 100A, the feeder pipe sections 100A, 100B are tack welded to prevent them from becoming misaligned. As illustrated in FIG. 28, preferably at least six tack welds 104 are used. Next, the weld tool assembly 30 begins the welding process. The weld tool assembly 30 is capable of performing root, filler, and cap passes for both stringer and weave type welding processes. As illustrated in FIGS. 30 and 31, the weld tool assembly 30 preferably makes at least seven passes. During the welding process, the weld tool assembly 30 adjusts to ensure that the torch assembly 38 is in the proper position for making the root, filler, and cap passes. As described above, the torch assembly 38 may be moved inwardly (towards) or outwardly (away from) the feeder pipe sections 10A and 100B, and may be moved axially along the feeder pipe sections by adjusting the pivot bars 64 and 66 to make adjacent passes. Furthermore, the torch assembly 38 may be moved radially around the circumference of the feeder pipe sections 100A and 100B by the arc length gear 33 and travel gear 34 moving together. After each pass, a cool down period is allotted so that each weld pass may be inspected with the vision system 78. If the torch assembly 38 needs to be removed, repaired, or rebuilt during the welding process, the torch assembly may be removed from the frame 32 without removing the entire weld head assembly 12.

After the welding process is completed, the weld head assembly 12 is retracted from the confined space between the feeder pipes 100. This is accomplished by moving the torch assembly 38 to a “home” position so that the weld head assembly 12 can be disengaged from the feeder pipe sections 100A and 100B. The manual control is then used to disengage the clamp assembly 31 from the feeder pipe section 100A (or 100B) to allow the weld head assembly 12 to detach from the feeder pipe section 100A (or 100B). The weld head assembly 12 is then rotated away from the feeder pipe 100 and withdrawn from the reactor.

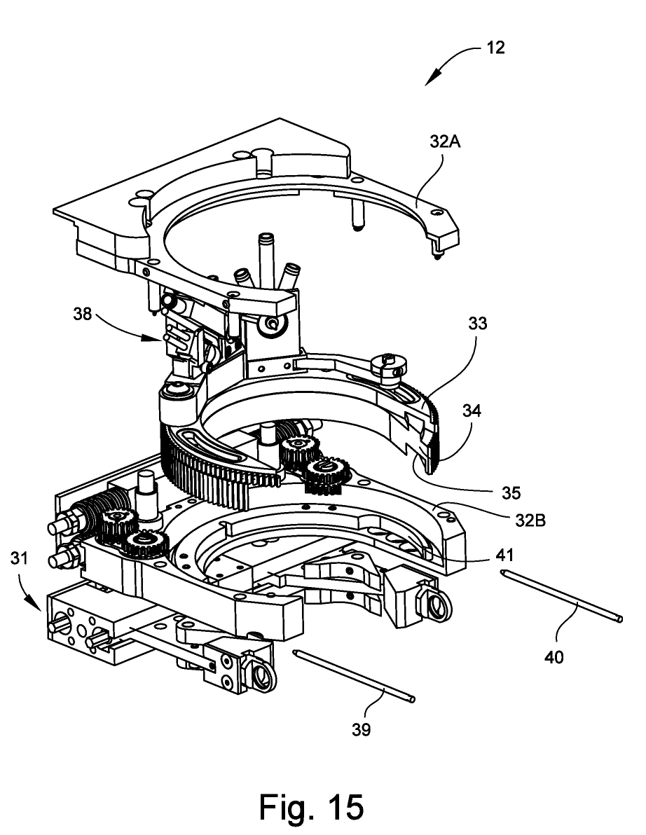

In the event of a power loss or system failure, manual recovery of the weld head assembly 12 may be executed in any of the following ways:
(1) If the gear train assemblies 44 and 46 are operative but a motor or the control has failed, the motor housing 11 may be accessed through the panel 19 to replace the defective motor or to manually drive the gear train assemblies by means of the drive shafts 20 and 21.
(2) If a drive shaft 20, 21 or a coupling failure has occurred in the insertion tube 13, the insertion tube may be accessed to replace the defective shaft 20, 21 and the motor re-installed to drive the gear train assembly 44, 46.
(3) If a gear train assembly 44, 46 has seized, which inhibits the ability to either electrically or manually drive the drive shafts 20, 21, the weld head assembly 12 can be separated using the separation pins 39 and 40, as shown in FIG. 15. Upon removal of the separation pins 39 and 40, embedded springs permit the upper frame plate 32A to be released from the main frame housing 32B. Upon removal of the frame plate 32A, arc length gear 33 and travel gear 34 may be separated from the frame housing 32B, and torch assembly 38 and cable management assembly may be removed. Once the frame plate 32A, gears 33 and 34, torch assembly 38, and cable management assembly have been removed, the frame housing 32B and clamp assembly 31 may be removed.
(4) If the failure has occurred which inhibits the release of the clamp assembly 31, release pins 67 and 68 can be removed to release the clamping jaws 61 from the clamp assembly 31, thereby allowing the clamp assembly to be removed from the weld location.

One or more preferred embodiments of a welding system according to the present invention have been described herein. However, various details of the invention may be changed without departing from its scope. Furthermore, the foregoing description of the preferred embodiments of the invention and best mode for practicing the invention are provided for the purpose of illustration only and by way of limitation.

That which is claimed is:

1. A welding system comprising:
a motor housing;
a weld head assembly; and
an insertion tube extending between the motor housing and the weld head assembly such that the weld head assembly is remote from the motor housing;
wherein the motor housing houses at least one motor for positioning the weld head assembly relative to a pipe.

2. The welding system of claim 1, wherein at least one of the motor housing and the insertion tube are supported on a platform for rotational and translational movement of the weld head assembly.

3. The welding system of claim 1, wherein the weld head assembly comprises:
a clamp assembly for attaching the weld head assembly to the pipe; and
a weld tool assembly mounted adjacent the clamp assembly for performing a welding process on the pipe.

4. The welding system of claim 3, wherein the weld tool assembly comprises a frame for supporting an arc length gear, a travel gear, and a torch assembly and wherein the arc length gear and the travel gear cooperate to adjust the distance between the torch assembly and the pipe when the weld head assembly is attached to the pipe.

5. The welding system of claim 4, wherein the arc length gear and the travel gear are positioned in stacked relation and wherein the arc length gear and the travel gear rotate relative to one another to increase and decrease the distance between the torch assembly and the pipe when the weld head assembly is attached to the pipe.

6. The welding system of claim 5, wherein the weld tool assembly further comprises at least one drive shaft operably coupled to the motor housed within the motor housing for rotating the arc length gear and the travel gear relative to one another.

7. The welding system of claim 4, wherein the arc length gear and the travel gear cooperate to adjust the location of the torch assembly around the circumference of the pipe when the weld head assembly is attached to the pipe.

8. The welding system of claim 7, wherein the arc length gear and the travel gear rotate together to move the location of the torch assembly around the circumference of the pipe when the weld head assembly is attached to the pipe.

9. The welding system of claim 4, wherein the weld tool assembly further comprises at least one drive shaft operably coupled to the motor housed within the motor housing for rotating the arc length gear and the travel gear relative to one another.

10. The welding system of claim 3, wherein the clamp assembly comprises clamping jaws having a plurality of fingers that make contact with the pipe to attach the weld head assembly to the pipe.

11. The welding system of claim 3, wherein the clamp assembly comprises a cross-seam axis assembly for providing linear adjustment of the weld head assembly in an axial direction along the pipe.

12. The welding system of claim 11, wherein the cross-seam axis assembly comprises a lead screw assembly operably coupled to a drive shaft within the insertion tube for driving a pair of pivot bars pivotally attached to the weld tool assembly such that the pivot bars move the weld tool assembly in the axial direction to position a torch assembly over a weld location on the pipe.

13. A weld head assembly for a welding system adapted for performing a welding process on a pipe in a confined space, the weld head assembly comprising:
a clamp assembly for attaching the weld head assembly to the pipe; and
a weld tool assembly mounted adjacent the clamp assembly for performing the welding process on the pipe, the weld tool assembly having a frame for supporting an arc length gear, a travel gear, and a torch assembly, the arc length gear and the travel gear cooperating to adjust the distance between the torch assembly and the pipe when the weld head assembly is attached to the pipe.

14. The weld head assembly of claim 13, wherein the arc length gear and the travel gear are positioned in stacked relation and wherein the arc length gear and the travel gear rotate relative to one another to increase and decrease the distance between the torch assembly and the pipe when the weld head assembly is attached to the pipe.

15. The weld head assembly of claim 13, wherein the arc length gear and the travel gear rotate together to move the location of the torch assembly around the circumference of the pipe when the weld head assembly is attached to the pipe.

16. The weld head assembly of claim 13, wherein the weld tool assembly further comprises at least one drive shaft operably coupled to a motor housed within a motor housing remote from the weld head assembly for moving the arc length gear and the travel gear.

17. The weld head assembly of claim 13, wherein the clamp assembly comprises clamping jaws having a plurality of fingers that make contact with the pipe to attach the weld head assembly to the pipe.

18. The weld head assembly of claim 13, wherein the clamp assembly comprises a cross-seam axis assembly for providing linear adjustment of the weld head assembly in an axial direction along the pipe.

19. The weld head assembly of claim 18, wherein the cross-seam axis assembly comprises a lead screw assembly operably coupled to a drive shaft for driving a pair of pivot bars pivotally attached to the weld tool assembly such that the pivot bars move the weld tool assembly in the axial direction to position the torch assembly over a weld location on the pipe.

20. A method of welding a pipe in a confined space, the method comprising:
providing a welding system comprising a motor housing, a weld head assembly having a clamp assembly and a weld tool assembly, and an insertion tube extending between the motor housing and the weld head assembly such that the weld head assembly is remote from the motor housing;
inserting the weld head assembly into the confined space using the insertion tube;
positioning the weld head assembly around the pipe using at least one motor housed within the motor housing;
attaching the weld head assembly onto the pipe using the clamp assembly; and
welding the pipe using the weld tool assembly.
